(19) United States
(12) Patent Application Publication
(10) Pub. No.: US 2005/0234927 A1
(43) Pub. Date: Oct. 20, 2005

(54) Efficient Transfer of Data Between a Database Server and a Database Client

(75) Inventors: Amit Bande, Bangalore (IN); Sreekumar K. Seshadri, Bangalore (IN); Krishna Mohan Itikarlapalli, Bangalore (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: Oracle International Corporation

(21) Appl. No.: 10/708,940

(22) Filed: Apr. 1, 2004

(51) Int. Cl. G06F 7/00

(52) U.S. Cl. 707/100

(57) ABSTRACT

An end system representing a database server or a database client determines whether to send data in compressed format, and sends the data in a compressed format only if it is determined to send the data in compressed format. In an embodiment implemented using software instructions, a function (set of instructions) is implemented to return one logical value to send data in compressed format and other logical value otherwise.

### BACKGROUND OF INVENTION

1. Field of the Invention

The present invention relates to databases, and more specifically to a method and apparatus enabling efficient transfer of data between a database server and a database client.

2. Related Art

A database server generally refers to a digital processing system which enables storage and access of data in the form of structured requests. In general, related data is stored in the form of one or more databases (e.g., in the form of tables in the case of relational databases), and storage/access requests are used for storing/accessing the contained data. Structured query language (SQL) is an example language used to store/access data in the form of relational databases, as is well known in the relevant arts.

A database client is often used to generate such structured queries, and interact with database servers using a network. Often, the database clients provide a convenient interface using which a user may store/access data from various databases. Data corresponding to the related requests (from the client to the server) and responses are transferred on the network.

It is often desirable that data transfers be performed efficiently. For example, it may be desirable to optimize one or more of volume of data transferred, processing power consumed, time to transfer the data, etc.

### BRIEF DESCRIPTION OF DRAWINGS

The present invention will be described with reference to the accompanying drawings briefly described below.

FIG. 1 is a block diagram illustrating an example environment in which the present invention can be implemented.

FIG. 2 is a flow-chart illustrating the manner in which data can be transferred efficiently between a database server and a database client according to an aspect of present invention.

FIG. 3A is a block diagram of a database client implemented according to an aspect of the present invention.

FIG. 3B is a block diagram of a database server implemented according to an aspect of the present invention.

FIG. 4 is a block diagram illustrating the details of an embodiment of a digital processing system implemented substantially in the form of a software according to an aspect of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

According to an aspect of the present invention, a digital processing system representing a database server/database client (end systems) determines whether to sent data in a compressed format. Such a determination may be based on any set of desired criteria. The data is sent in a compressed format only if it is determined that the criteria is better satisfied by compressing the data and transmitting. As a result, data transfers between a database server and a client system may be performed while satisfying the desired criteria.

In one embodiment, the determination of whether to compress is based on multiple considerations. For example, the processing load on both systems may be examined and compression may be avoided if the load on either end system is over a threshold. Similarly, the type of the data to be transmitted may be examined, and if the data type does not lend to compression (e.g., binary type), compression may be avoided. As another example, if the network speed is very high (i.e., probability that large amount of data will be transferred quickly exceeds a corresponding threshold), compression may be avoided.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well_known structures or operations are not shown in detail to avoid obscuring the invention.

2. Example Environment

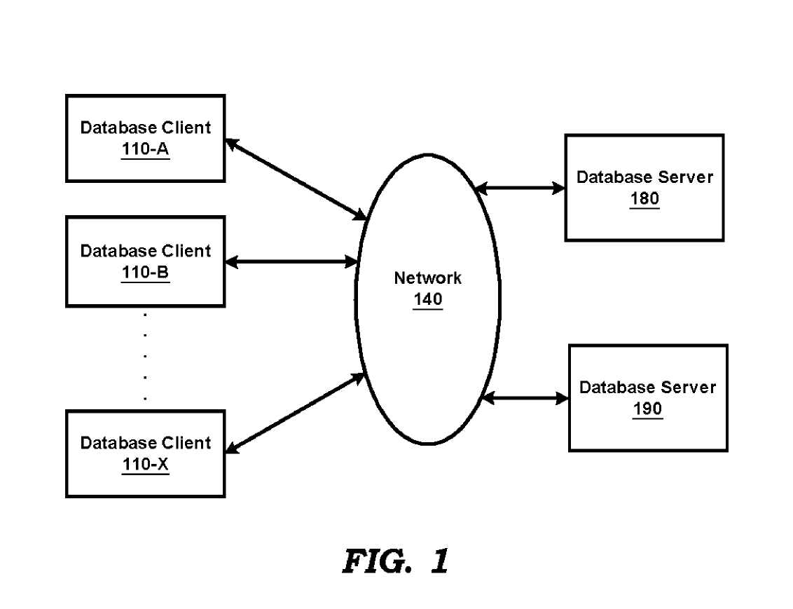

FIG. 1 is a block diagram illustrating the details of an example environment in which the present invention can be implemented. The block diagram is shown containing database client systems 110-A through 110-X, network 140, and database servers 180 and 190. Each block is described below in detail.

It should be understood that only representative example components are shown in the diagram so as not to obscure various features of the present invention. However, it will be apparent to one skilled in the relevant arts that environments may contains many other (both in number and type) components implemented, without departing from the scope and spirit of various aspects of the present invention.

Network 140 provides connectivity between database client systems 110-A through 110-X and database server 190. Network 140 may contain several devices (e.g., bridges, routers, modems, communication links, etc.,) operating according to protocols such as TCP/IP well known in the relevant arts. However, other forms (e.g., point-to-point private network using proprietary protocols or ATM-based network) can also be used to provide connectivity between the client systems and the database system.

Database clients 110-A through 110-X enable users to store/retrieve data into/from database server 190. For illustration, it is assumed that user applications supported by database client 110-A may need to store/retrieve data from database server 190. However, database client 110-A may access other database servers (not shown) and other database clients (110-B through 110-X) may also access database server 190 in a similar manner.

Database client 110-A may support multiple user applications which enable users (by providing an user interface) to store/retrieve data into/from database server 190. In general, a convenient interface is provided for user to specify data of interest for retrieval or data to be stored, and corresponding requests are generated. The requests are transmitted on network 140 and corresponding responses are received from database server 190.

Each of database servers 180 and 190 provides a repository for storing various pieces of information (or data), and may store/retrieve data on receiving a request (from database client). For example, name, address, employee code, salary details, attendance details etc., corresponding to each employee of the organization can be stored and retrieved based on the corresponding requests. In general, database servers allow database clients to store/retrieve desired data using structured queries. In addition, communication may be present between database servers as well, From the above, it may be appreciated that severaland responses (commonly referred to as “communication packets”) are transmitted on network 140 between a client system and a database server, as well as between two database servers, or in general end systems. It may be further appreciated that different types of data may be transmitted depending on the type of end systems. For example, one end system may store software instructions (either in the form of executable object code or text), and the software instructions may be transferred for execution on the other end system.

It may be desirable to transfer the related data efficiently. The description is continued with reference to a manner in which data between two end systems in a database environment (e.g., database client 110-A and database server 190) can be transferred efficiently according to an aspect of the present invention.

3. Transferring Data Efficiently

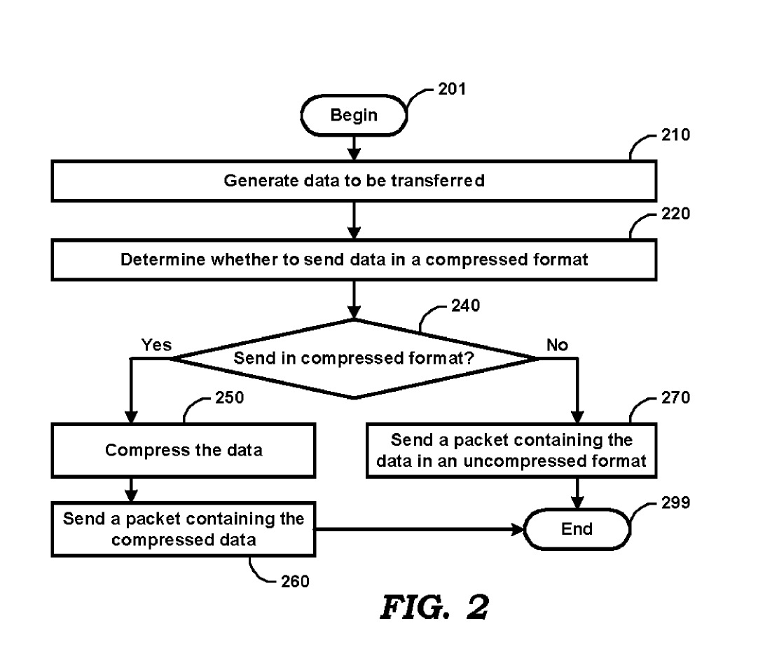

FIG. 2 is a flow-chart illustrating the manner in which data can be transferred efficiently between a database server and a database client according to an aspect of present invention. The method is described with reference to FIG. 1, however, the method may be implemented between other end systems as well without deviating from the scope and spirit of several aspects of the present invention.

It should be understood that the flow-chart can be used in the transfer of data in one or both directions between a database client and a database server (or between database servers). Accordingly, the flow-chart is described with respect to a first end system (e.g., database client 110-A) sending a communication packet to a second end system (e.g., database server 190). The method begins in step 201 in which control immediately passes to step 210.

In step 210, a first end system generates data to be transferred. For example, database server 190 retrieves data corresponding to a request sent by database client 110-A. As another example, database client 110-A generates a request based on the input provided by user indicating the data that needs to be stored into database server 190. Data may be generated using various computations as well, as appropriate in the specific context.

In step 220, the first end system determines whether to send data in a compressed format. The determination can be based on various criteria. In one embodiment described below in further detail, various parameters such as the processing load on the two end systems, the network speed, the data type, etc., are considered in making a determination as to whether to send data in the compressed format.

In step 240, control is transferred to step 250 if data is to be compressed, otherwise to step 270. In step 250, the data is compressed. Various techniques (e.g., Huffman coding) well known in the relevant arts can be used for the compression. In step 260, the compressed data is sent on network 140 in a packet. Control then passes to step 299. In step 270, the (uncompressed) data is transmitted in a packet to the second end system. Control again passes to step 299.

In one embodiment, both the compressed data and the uncompressed data are sent in the form of TCP/IP (UDP/IP) packets. A custom format may be defined within the TCP/IP framework to indicate whether the data is present in compressed format or uncompressed format. The definition and use of such custom formats will be apparent to one skilled in the relevant arts.

By using the approach of above, compression technologies can be made use of to optimize any desired criteria. The description is continued with respect to various parameters that may be examined to determine whether data needs to be sent in compressed format to optimize such time.

4. Parameters Examined

As noted above, various parameters may be considered to determine whether to send the data in compressed format. In one embodiment, the following parameters are considered for each of such estimates: (a) Processing load; (b) Network speed; (c) Data type; and (d) Data size. The manner in which the parameters are measured and used in an embodiment is described below.

5. Processing Load

In general, the data can be compressed and uncompressed faster if processing resources in the end systems can be allocated for the corresponding task. Accordingly, in one embodiment, the processing load in both the end systems is determined, and compression is avoided if the processing load in either end system is very high (exceeds a threshold). In other words, the approach avoids overload (or processing requirements) on either of the end machines (for compression or decompression) by not using the compression approach when appropriate.

The processing load on each end system may be determined periodically (instead of for every time a decision on compression needs to be made). For example, the processing load in the previous 10 minutes may be determined every 10 minutes, and if the percentage of utilization exceeds a specific threshold, compression may be avoided until the processing load is examined on the end system again. Processing load may be determined in a known way using various system tools provided on the specific end system.

6. Type of Data

As is well known, compression may substantially decrease the size (number of bits) in the case of specific data types and marginally decrease the size in the case of other data types. For example, character type of data may be compressed (up to 50%) substantially whereas binary type of data may be compressed marginally (up to 15%).

In one embodiment, Oracle databases may store data in different data types (e.g., cLOB, VarChar2, Num etc.,) and data stored in cLOB, VarChar2 data type may be compressed, whereas data stored in Num data type may be sent uncompressed. Thus, depending on the type of data, a decision may be made not to compress.

7. Data Size

In general, compression is more suited when the data size to be transported is correspondingly big since the reduction in the number of bytes would typically be proportionate to the data size. Thus, for extremely small data sizes, compression option may be ignored. In addition, various approaches may be used to determine the extent of compression that is likely to be accomplished (e.g., based on prior compression transactions or by examining the nature of data), and compression option may be ignored if substantial compression in unlikely.

8. Network Speed

In general, a network transferring data at high speeds would transfer data packets fast (i.e., cause less time to elapse).may be suitable if network speed is low since the amount of data to be transferred would be low due to the compressed format.

Accordingly, in one embodiment, network speed is estimated based on a round-trip time taken for a packet to be sent and received. An ICMP echo type packet may be sent with a time stamp (indicating the time point at which packet is transmitted) and computing the delay when the packet is received back at the sending end. The round trip time or delay may be used to estimate the network speed.

Alternatively, a time stamp (“first time stamp”) may be included along with other application related packets (e.g., using techniques such as piggybacking), and the other end system may be designed to include a time stamp (“receive time stamp”) of receiving the packet. Another packet may be sent with the first time stamp, receive time stamp and another time stamp (“send time stamp”).

Based on a time (“fourth time stamp”) at which the another packet is received, the total round trip time may be estimated using the four time stamps in a known way. If the round trip time is less than a pre-specified threshold, the network speed may be considered to be high, and the compression option may be avoided.

Thus, whether data needs to be compressed or not is determined on various parameters such as those noted above. In an embodiment, the decision whether to compress or not is implemented in the form of sub-routine, which returns a true value if compression is to be used and a false value otherwise (consistent with the considerations noted above).

The description is continued with reference to the details of embodiments of database client and database server. Merely for illustration, the description is provided assuming communication between a database server and a database client. However, various aspects of the present invention are applicable to communication between database servers as well.

9. Database Client

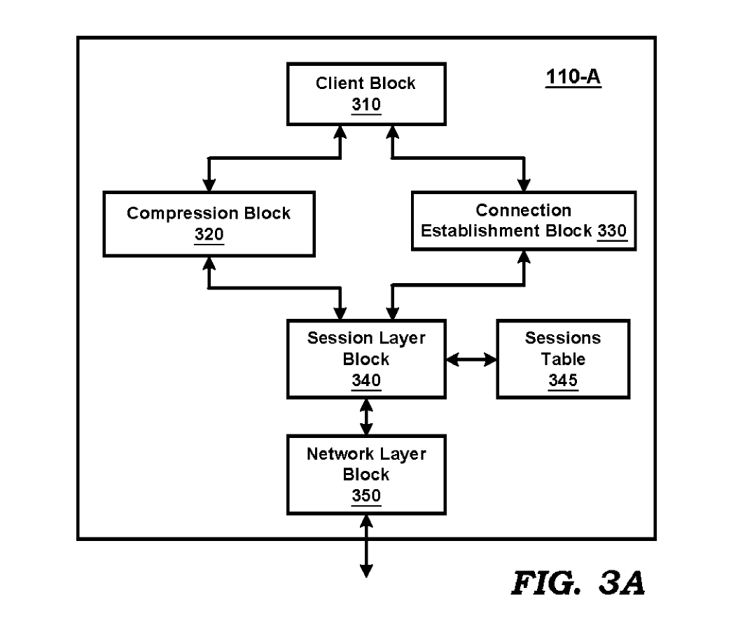

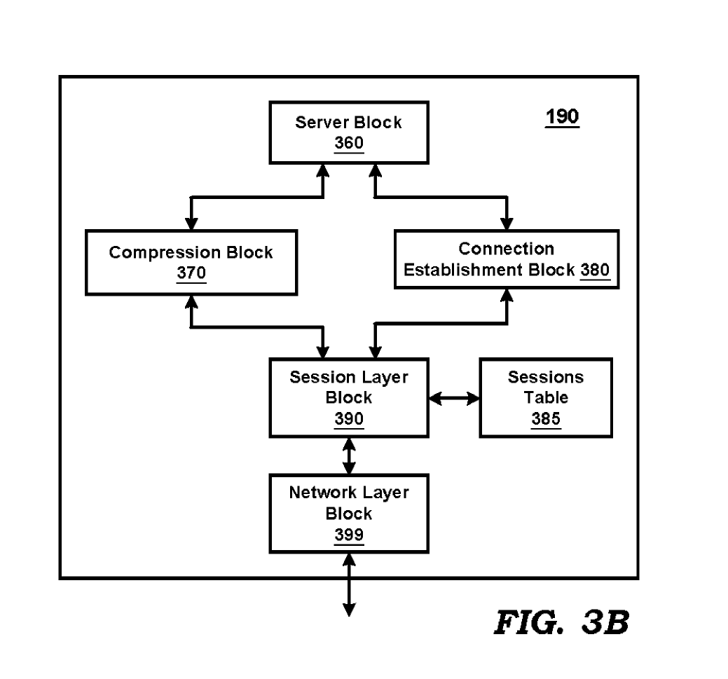

FIG. 3A is a block diagram illustrating the details of an embodiment of database client 110-A implemented according to an aspect of the present invention. The block diagram is shown containing client block 310, compression block 320, connection establishment block 330, session layer block 340, and network layer block 350. For illustration, the description is provided with reference to FIGS. 1 and 2. Each block is described in detail below.

Client block 310 supports multiple applications which may store/retrieve data from multiple databases contained in database server 190. Client block 310 generates a request to set up a database connection and sends the request to connection establishment block 330. In response, client block 310 receives a connection identifier to send database queries (or requests) to database server 190.

Client block 310 generates data to be transferred, and passes to compression block 320 the data along with the connection identifier on which to transfer the data. Also, data packets (responses) received from compression block 320 are also forwarded to a corresponding application.

Connection establishment block 330 sets up a database connection (with database server 190) by interfacing with session layer block 340 in response to a related request received from client block 310. Sessions layer block 340 provides a session (e.g., unique source port number for each connection) for each connection sought to be established. In addition, the payload provided by compression block 320 is placed in packets with appropriate headers and forwarded to network layer block 350.

The mapping of port number to database connection identifier may be maintained in sessions table 345. The information in sessions table 345 is used to transmit data from each user application on appropriate session (i.e., source/destination IP address and port combination), and to pass data received on each session to corresponding user application.

Network layer block 350 receives outbound packets from sessions layer block 340, and sends the packets on network 140. The IP packet payload contained in inbound data may be sent to sessions layer block 340. Connection establishment block 330, sessions layer block 340 and network layer block 350 may be implemented in a known way.

Compression block 320 receives data from client block 310 and determines whether to send the data in a compressed format. The determination may be performed, for example, using the approach(es) described above. If needed (according to the determination), the data is compressed. The data (in compressed or uncompressed format) is passed to session layer block 340.

Compression block 320 examines the payload data received from session layer block 340 and determines whether the data requires decompression (e.g., by examining the packet format). data is decompressed if required. The data is passed to the appropriate user application based on the specific session/database connection on which the packet is received.

The database client may thus determine whether data has to be sent in compressed format or not, and accordingly data may be sent in either compressed or uncompressed format. The decision whether to send data in compressed format is dynamically made based on the parameters at that time point. The description is continued with reference to the manner in which database server 190 is implemented in one embodiment.

9. Database Server

FIG. 3B is a block diagram illustrating the details of an embodiment of database server 190 implemented according to an aspect of the present invention. The block diagram is shown containing server block 360, compression block 370, connection establishment block 380, sessions layer block 390, and network layer block 399.

In one embodiment, compression block 370, sessions layer block 390, and network layer block 399 are respectively implemented similar to (except that interface is with server block 360, as opposed to client block 310) and to cooperate with compression block 320, sessions layer block 340, and network layer block 350. The details of these blocks are not repeated in the interest of conciseness.

Connection establishment block 380 operates cooperatively with connection establishment block 330 to enable setup and termination of database connections. The database connection identifiers are passed to server block 360.

Server block 360 processes various requests received from client systems, and uses compression block 370 while sending data according to various aspects of the present invention. In response to retrieval queries, server block 360 retrieves data from a corresponding database, and sends the data to compression block 370. Similarly, data (in uncompressed form) associated with a store request may also be received from compression block 370, and the data is stored in a database according to the store request.

The description is continued with respect to a manner in which an embodiment of digital processing system representing database client 110-A or database server 190 is implemented substantially in the form of a software.

10. Software Implementation

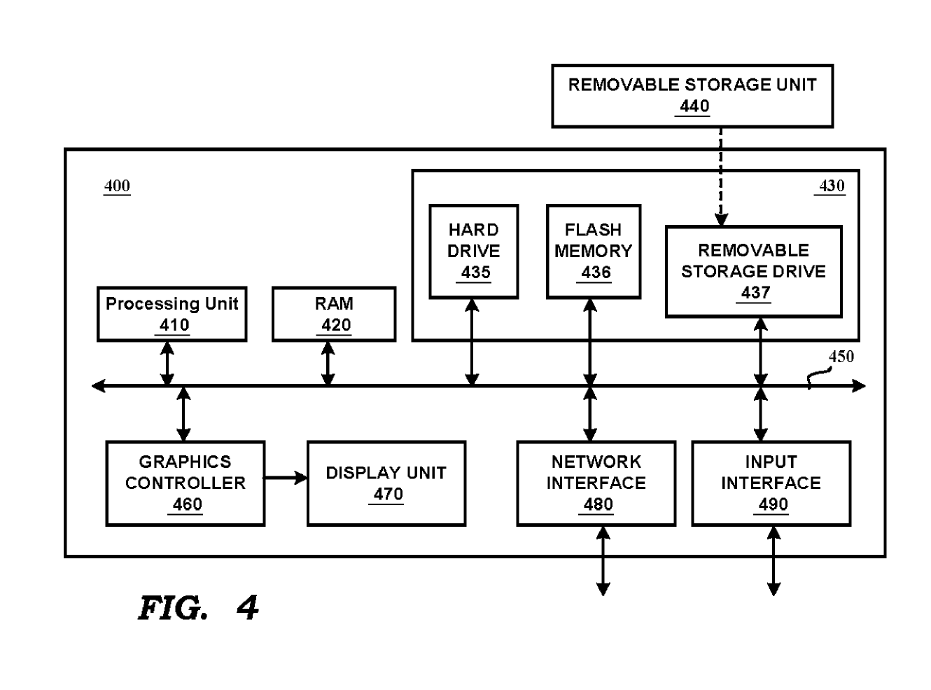

FIG. 4 is a block diagram illustrating the details of digital processing system 400 implemented substantially in the form of software in an embodiment of the present invention. Digital processing system 400 may contain one or more processors such as processing unit 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

Processing unit 410 may execute instructions stored in RAM 420 to provide several features of the present invention. Processing unit 410 may contain multiple processors, with each processor potentially being designed for a specific task. Alternatively, processing unit 410 may contain only a single processor. RAM 420 may receive instructions and data from secondary memory 430 and network interface 480 using communication path 450.

Graphics controller 460 generates display signals (e.g., in RGB format) to display unit 470 based on data/instructions received from processing unit 410. Display unit 470 contains a display screen to display the images defined by the display signals. Input interface 490 may correspond to a key_board and/or mouse, and generally enables a user to provide various inputs (e.g., request/query). Network interface 480 enables some of the inputs (and outputs) to be provided on a network and also to interface with database server 190 or database client 110-A through 110-X. Display unit 470, input interface 490 and network interface 480 may be implemented in a known way.

Secondary memory 430 may contain hard drive 435, flash memory 436 and removable storage drive 437. Secondary memory 230 may store the data (e.g., processing load, network speed, session identifier, connection path identifier etc) and software instructions which cause digital processing system 400 to provide several features in accordance with the present invention. Some or all of the data and instructions may be provided on removable storage unit 440, and the data and instructions may be read and provided by removable storage drive 437 to processing unit 410. Floppy drive, magnetic tape drive, CD_ROM drive, DVD Drive, Flash memory, removable memory chip (PCMCIA Card, EPROM) are examples of such removable storage drive 437.

Removable storage unit 440 may be implemented using medium and storage format compatible with removable storage drive 437 such that removable storage drive 437 can read the data and instructions. Thus, removable storage unit 440 includes a computer readable storage medium having stored therein computer software and/or data.

In this document, the term “computer program product” is used to generally refer to removable storage unit 440 or hard disk installed in hard drive 435. These computer program products are means for providing software to digital processing system 400. Processing unit 410 may retrieve the software instructions, and execute the instructions to provide various features of the present invention as described above.

Thus, efficient transfer of data between a database server and a database client may be supported according to an aspect of the present invention.

### 11. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

1. A method of transferring data from a first end system to a second end system, wherein said first end system and said second end system are connected by a network, said method being performed in said first end system, said method comprising:
determining whether to send said data in a compressed format;
if it is determined to send said data in said compressed format, compressing said data to generate compressed data using a compression approach and sending said compressed data to said second end system on said network; and
otherwise, sending said data in an uncompressed format to said second end system on said network.

2. The method of claim 1, wherein said determining checks a processing load on each of said first end system and said second end system, and determines not to send said data in said compressed format if the processing load on either end system is determined to be more than a first threshold.

3. The method of claim 2, wherein said processing load is checked periodically.

4. The method of claim 1, wherein said determining checks a type of said data and determines not to send said data in said compressed format if said type does not lend to substantial data compression.

5. The method of claim 1, wherein said determining examines a size of said data and determines not to send said data in said compressed format if said size is small.

6. The method of claim 5, wherein said determining checks a speed of data transfer on said network and determines not to use said compressed format if said speed is high.

7. The method of claim 6, wherein said speed is determined by sending an ICMP echo packet.

8. The method of claim 6, wherein said speed is determined by including a first local time stamp in a packet sent to said second end system, and receiving a second time stamp and a third time stamp from said second end system at a time specified by a fourth local time stamp, wherein said second time stamp indicates a time at which said packet is received in said second end system and said third time stamp indicates a time at which said packet is send from said second end system, wherein said speed is determined based on said first local time stamp, said second time stamp, said third time stamp, and said fourth time stamp.

9. The method of claim 1, wherein said first end system comprises one of a database server and a database client, and said second end system comprises the other one of said database server and said database client.

10. The method of claim 1, wherein said data comprises software instructions.

11. A computer readable medium carrying one or more sequences of instructions for causing a first end system to transfer a second end system, wherein said first end system and said second end system are connected by a network, wherein execution of said one or more sequences of instructions by one or more processors contained in said first end system causes said one or more processors to perform the actions of:
determining whether to send said data in a compressed format;
if it is determined to send said data in said compressed format, compressing said data to generate compressed data using a compression approach and sending said compressed data to said second end system on said network; and
otherwise, sending said data in an uncompressed format to said second end system on said network.

12. The computer readable medium of claim 1, wherein said determining checks a processing load on each of said first end system and said second end system, and determines not to send said data in said compressed format if the processing load on either end system is determined to be more than a first threshold.

13. The computer readable medium of claim 12, wherein said processing load is checked periodically.

14. The computer readable medium of claim 1, wherein said determining checks a type of said data and determines not to send said data in said compressed format if said type does not lend to substantial data compression.

15. The computer readable medium of claim 1, wherein said determining examines a size of said data and determines not to send said data in said compressed format if said size is small.

16. The computer readable medium of claim 15, wherein said determining checks a speed of data transfer on said network and determines not to use said compressed format if said speed is above a second threshold.

17. The computer readable medium of claim 16, wherein said speed is determined by sending an ICMP echo packet.

18. The computer readable medium of claim 16, wherein said speed is determined by including a first local time stamp in a packet sent to said second end system, and receiving a second time stamp and a third time stamp from said second end system at a time specified by a fourth local time stamp, wherein said second time stamp indicates a time at which said packet is received in said second end system and said third time stamp indicates a time at which said packet is send from said second end system, wherein said speed is determined based on said first local time stamp, said second time stamp, said third time stamp, and said fourth time stamp.

19. The computer readable medium of claim 1, wherein said first end system comprises one of a database server and a database client, and said second end system comprises the other one of said database server and said database client.

20. The computer readable medium of claim 1, wherein said data comprises software instructions.

21. An apparatus for transferring data from a first end system to a second end system, wherein said first end system and said second end system are connected by a network, said apparatus being performed in said first end system, said apparatus comprising:
means for determining whether to send said data in a compressed format;
means for compressing said data to generate compressed data using a compression approach and means for sending said compressed data to said second end system on said network if it is determined to send said data in said compressed format; and
means for sending said data in an uncompressed format to said second end system on said network otherwise.

22. The apparatus of claim 21, wherein said means for determining checks a processing load on each of said first end system and said second end system, and determines not to send said data in said compressed format if the processing load on either end system is determined to be more than a third threshold.

23. The apparatus of claim 22, wherein said processing load is checked periodically.

24. The apparatus of claim 21, wherein said means for determining checks a type of said data and determines not to send said data in said compressed format if said type does not lend to substantial data compression.

25. The apparatus of claim 21, wherein said means for determining examines a size of said data and determines not to send said data in said compressed format if said size is small.

26. The apparatus of claim 25, wherein said means for determining checks a speed of data transfer on said network and determines not to use said compressed format if said speed is high.

27. The apparatus of claim 26, wherein said means for determining determines said speed by sending an ICMP echo packet.

28. The apparatus of claim 26, wherein said means for determining includes a first local time stamp in a packet sent to said second end system, and receives a second time stamp and a third time stamp from said second end system at a time specified by a fourth local time stamp, wherein said second time stamp indicates a time at which said packet is received in said second end system and said third time stamp indicates a time at which said packet is send from said second end system, wherein said speed is determined based on said first local time stamp, said second time stamp, said third time stamp, and said fourth time stamp.

29. The apparatus of claim 21, wherein said first end system comprises one of a database server and a database client, and said second end system comprises the other one of said database server and said database client.
